(19) United States
(12) Patent Application Publication
(10) Pub. No.: US 2007/0272280 A1
(43) Pub. Date: Nov. 29, 2007

(54) System and method for spray cleaning ceramic packages

(75) Inventor: Jane Qian Liu, Plano, TX (US)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED

(21) Appl. No.: 11/439,681

(22) Filed: May 24, 2006

(51) Int. Cl. B08B 3/00

(52) U.S. Cl. 134/34

(57) ABSTRACT

In accordance with the teachings of the present invention a system and method for spray cleaning ceramic packages are provided. In a particular embodiment, the system includes a process chamber, a turntable operable to rotate within the process chamber, at least one cassette operable to be coupled with the turntable and configured to hold one or more ceramic packages, and a spray post operable to distribute a cleaning solution onto the one or more ceramic packages. In a particular embodiment, the method includes loading a plurality of digital micro-mirror device ceramic packages into a process chamber of a spray cleaning system, spraying the ceramic packages inside the process chamber with a cleaning solution, rinsing the ceramic packages inside the process chamber with a rinse solution comprising water, draining the process chamber of the cleaning solution and rinse solution, and drying the ceramic packages inside the process chamber.

### TECHNICAL FIELD

This invention relates generally to manufacturing microelectronic devices and, more particularly, to a system and method for spray cleaning ceramic packages.

### BACKGROUND

Ceramic packages and substrates are often used to package microelectronic devices such as integrated circuits and digital micro-mirror devices (“DMDs”). Typically, these ceramic packages or substrates are manufactured separately from the microelectronic device they are used to package and then coupled with the device at a later time. Prior to using the ceramic package or substrate to package a microelectronic device, the ceramic package or substrate is cleaned to remove any debris or chemical residue leftover from manufacturing. Typically, this is accomplished by exposing the ceramic packages to a chemical bath comprising ammonium hydroxide, hydrogen peroxide, and water. After the chemical bath, the packages are then rinsed to remove any chemicals leftover from the bath, and spun dry under a nitrogen flow.

Although widely used, these chemical baths suffer from a variety of problems that can affect production yields. For example, the concentration of the chemical bath can change over time as chemicals, such as ammonium hydroxide, react with debris on the surface of the ceramic packages and/or leave solution due to evaporation. Additionally, chemical baths can become contaminated with debris from previous cleaning runs that remain suspended in the solution. Moreover, the process of bathing, rinsing, and drying the ceramic packages (and the waiting time between each step) allows several opportunities for waterspots to form on the surface of the ceramic packages before the packages are properly dried.

### SUMMARY

In accordance with the teachings of the present invention a system and method for spray cleaning ceramic packages are provided. In a particular embodiment, the system comprises a process chamber, a turntable operable to rotate within the process chamber, at least one cassette operable to be coupled with the turntable and configured to hold one or more ceramic packages, and a spray post operable to distribute a cleaning solution onto the one or more ceramic packages. In a particular embodiment, the method comprises loading a plurality of digital micro-mirror device ceramic packages into a process chamber of a spray cleaning system, spraying the ceramic packages inside the process chamber with a cleaning solution, rinsing the ceramic packages inside the process chamber with a rinse solution comprising water, draining the process chamber of the cleaning solution and rinse solution, and drying the ceramic packages inside the process chamber.

A technical advantage of particular embodiments of the present invention may include higher production yields compared to traditional methods of cleaning ceramic packages. By utilizing a single-chamber spray cleaning system, particular embodiments of the present invention are less susceptible to waterspotting that could lower production yields. Furthermore, due to the use of spray cleaning rather than traditional chemical baths, particular embodiments of the present invention may also be less susceptible to having debris from the ceramic packages contaminate the cleaning solution and/or may offer more consistent cleaning solution concentrations.

Another technical advantage of particular embodiments of the present invention may include improved cleaning efficiency. By utilizing spray cleaning rather than traditional chemical baths, particular embodiments of the present invention are able to provide more efficient cleaning through the use of both chemical and physical action.

It will be understood that the various embodiments of the present invention may include some, all, or none of the enumerated technical advantages. In addition other technical advantages of the present invention may be readily apparent to one skilled in the art from the figures, description, and claims included herein.

### BRIEF DESCRIPTION OF THE DRAWINGS

For a more complete understanding of the present invention and features and advantages thereof, reference is now made to the following description, taken in conjunction with the accompanying drawings, in which:

FIG. 1 illustrates a spray cleaning system in accordance with a particular embodiment of the present invention; and

FIG. 2 is a flow chart of a method of spray cleaning ceramic packages in accordance with a particular embodiment of the present invention.

### DESCRIPTION OF EXAMPLE EMBODIMENTS

In accordance with the teachings of the present invention a system and method for spray cleaning ceramic packages are provided. In a particular embodiment, the system comprises a process chamber, a turntable operable to rotate within the process chamber, at least one cassette operable to be coupled with the turntable and configured to hold one or more ceramic packages, and a spray post operable to distribute a cleaning solution onto the one or more ceramic packages. In a particular embodiment, the method comprises loading a plurality of digital micro-mirror device ceramic packages into a process chamber of a spray cleaning system, spraying the ceramic packages inside the process chamber with a cleaning solution, rinsing the ceramic packages inside the process chamber with a rinse solution comprising water, draining the process chamber of the cleaning solution and rinse solution, and drying the ceramic packages inside the process chamber. By spraying cleaning ceramic packages, particular embodiments of the present invention may provide higher production yields and/or more efficient cleansing than traditional methods of cleaning ceramic packages.

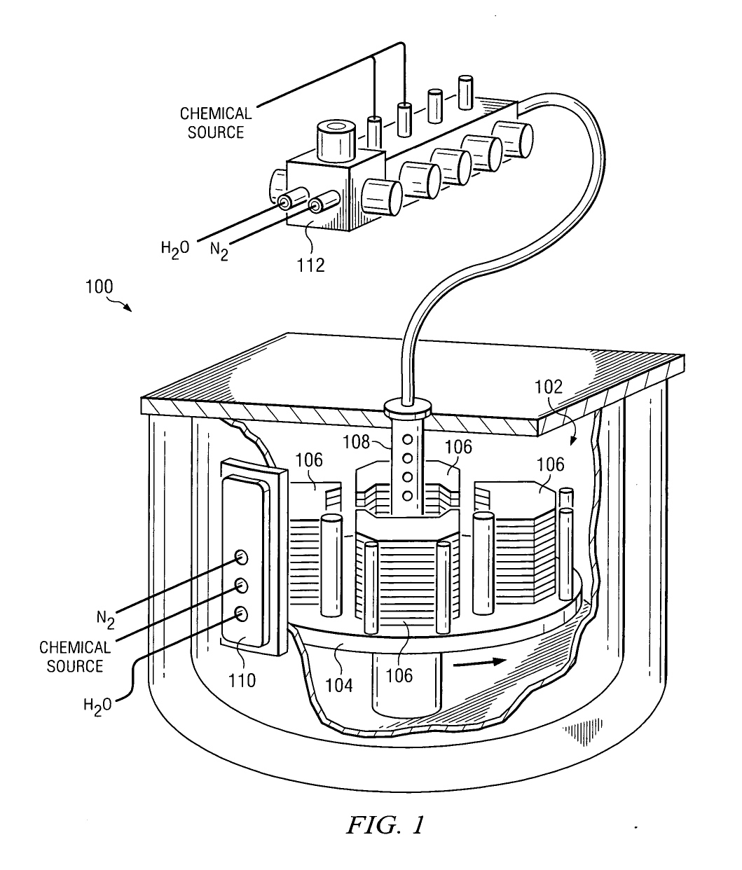

FIG. 1 illustrates a spray cleaning system 100 in accordance with a particular embodiment of the present invention. Spray cleaning system 100 is a single-chamber spray cleaning system that may be used to spray clean ceramic packages following manufacture, prior to using the ceramic packages to package microelectronic devices such as integrated circuits and digital micro-mirror devices. Generally, spray cleaning system 100 comprises a process chamber 102 that houses a turntable 104 and a central spray post 108. Turntable 104 is configured to hold a plurality of ceramic package cassettes 106 as turntable 104 rotates around central spray post 108, which is configured to spray a cleaning solution onto to the ceramic packages held by the plurality of cassettes 106. Each cassette 106 is configured to hold one or more ceramic packages for cleaning in process chamber 102. In particular embodiments, process chamber 102 also includes a side-bowl spray post 110, which, like central spray post 108, is also configured to spray cleaning solution onto the ceramic packages held by the plurality of cassettes 106. One example of a process chamber suitable for use in accordance with particular embodiments of the present invention is the Mercury® silicon wafer spray cleaning system manufactured by FSI International, Inc., of Chaska, Minn.

In particular embodiments, spray cleaning system 100 also includes a mixing manifold 112 operable to mix the cleaning solution prior to application to the ceramic packages. In particular embodiments, mixing manifold 112 may mix different chemicals into a desired cleaning solution. For example, in particular embodiments, mixing manifold 112 may be used to prepare a cleaning solution comprising ammonium hydroxide, hydrogen peroxide, and water in a 1:1:10 ratio. In other embodiments, spray cleaning system 100 may forego the use of a dedicated mixing manifold 112 and may instead utilize pre-mixed cleaning solutions. The cleaning solution, whether pre-mixed or supplied by mixing manifold 112, is then supplied, to central spray post 108 and/or side-bowl spray post 110, along with any necessary water or nitrogen, for distribution within process chamber 102.

After application of the cleaning solution, process chamber 102 may be drained of the cleaning solution. Central spray post 108 and/or side-bowl spray post 110 may then be used to apply rinse solution comprising water to the ceramic packages. This helps remove any cleaning solution that might have been left on the ceramic packages from the spray cleaning. After the ceramic packages have been rinsed with the rinse solution, the rinse solution is also drained from process chamber 102. Turntable 104 may then be used to spin-dry the ceramic packages. In particular embodiments of the present invention, this may be done under a nitrogen flow to help prevent waterspotting. After the ceramic packages are spun-dry, cassettes 106 may be removed from process chamber 102, and the ceramic packages may be removed from the cassettes 106. Thereafter, the ceramic packages may be used to package microelectronic devices, such as integrated circuits and DMDs.

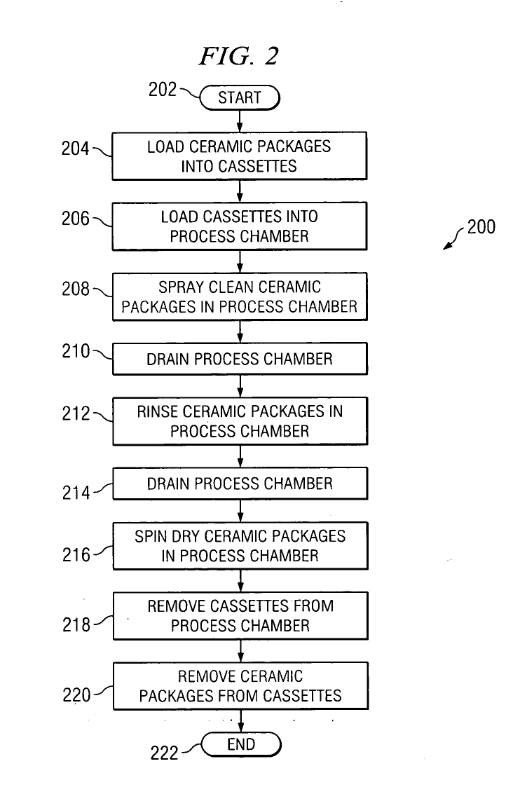

A better understanding of the present invention may be had by making reference to FIG. 2, which illustrates a flowchart 200 of a method of spray cleaning ceramic packages in accordance with a particular embodiment of the present invention. Flowchart 200 begins at step 202. At step 202, one or more ceramic packages are loading into one or more cassettes at step 204. At step 206, these cassettes are then loaded into the process chamber the spray cleaning system. After the spray cleaning system is sealed, the cassettes of ceramic packages are spray cleaned at step 208. In particular embodiments of the present invention, this is done with a cleaning solution comprising ammonium hydroxide, hydrogen peroxide, and water that is sprayed on the ceramic packages by a central and/or side-bowl spray post while the ceramic packages are spun on the turntable inside the process chamber. After the spray cleaning, the process chamber is drained at step 210. The ceramic packages are then rinsed with a rinse solution comprising water at step 212. Typically, this rinse solution is sprayed on the ceramic packages by the central and/or side-bow post while the ceramic packages are spun on the turntable inside the process chamber. After rinsing, the process chamber is again drained at step 214. The ceramic packages are then spun dry at step 216. In particular embodiments, this is done under a nitrogen flow to help prevent waterspotting. After the ceramic packages are dry, the cassettes are removed from the process chamber at step 218, and the ceramic packages are removed from the cassettes at step 220. Afterwards, flowchart 200 ends at step 222.

By spray cleaning ceramic packages as described above, particular embodiments of the present invention are able to offer production yields higher than those seen with traditional chemical bath cleaning processes. Unlike traditional chemical bath-based cleaning methods, particular embodiments of the present invention are able to offer more consistent concentrations of the cleaning solution due the fact that the cleaning solutions are left exposed to the atmosphere. Particular embodiments of the present invention may also require a smaller amount of cleaning solution due to the more effective cleaning of the spray action. Particular embodiments of the present invention may also utilize equipment that has a smaller footprint than equipment used for traditional chemical bath-based cleaning systems, reducing the total amount of floor space required for the ceramic package cleaning system.

Although particular embodiments of the method and apparatus of the present invention have been illustrated in the accompanying drawings and described in the foregoing detailed description, it will be understood that the invention is not limited to the embodiments disclosed, but is capable of numerous rearrangements, modifications, and substitutions without departing from the spirit of the invention as set forth and defined by the following claims.

What is claimed is:

1. A method of spray cleaning digital micro-mirror device ceramic packages, comprising:
loading a plurality of digital micro-mirror device ceramic packages into a process chamber of a spray cleaning system;
spraying the ceramic packages inside the process chamber with a cleaning solution;
rinsing the ceramic packages inside the process chamber with a rinse solution comprising water;
draining the process chamber of the cleaning solution and rinse solution; and
drying the ceramic packages inside the process chamber.

2. The method of claim 1, wherein the cleaning solution comprises ammonium hydroxide, hydrogen peroxide, and water.

3. The method of claim 1, wherein drying the ceramic packages comprises spin-drying the ceramic packages under a nitrogen flow.

4. The method of claim 1, wherein loading a plurality of digital micro-mirror device ceramic packages into a process chamber of a spray cleaning system comprises loading the plurality of digital micro-mirror device ceramic packages into one or more cassettes and loading the one or more cassettes into the process chamber of the spray cleaning system.

5. A method of spray cleaning microelectronic device ceramic packages, comprising:
loading a plurality of microelectronic device ceramic packages into a process chamber of a spray cleaning system;
spraying the ceramic packages inside the process chamber with a cleaning solution;
draining the process chamber of the cleaning solution; and
drying the ceramic packages inside the process chamber.

6. The method of claim 5, wherein the cleaning solution comprises ammonium hydroxide, hydrogen peroxide, and water.

7. The method of claim 5, wherein drying the ceramic packages comprises spin-drying the ceramic packages under a nitrogen flow.

8. The method of claim 5, further comprising rinsing the ceramic packages inside the process chamber with a rinse solution comprising water.

9. The method of claim 5, wherein loading a plurality of digital micro-mirror device ceramic packages into a process chamber of a spray cleaning system comprises loading the plurality of microelectronic device ceramic packages into one or more cassettes and loading the one or more cassettes into the process chamber of the spray cleaning system.

10. A system for spray cleaning ceramic packages, comprising:
a process chamber;
a turntable operable to rotate within the process chamber;
at least one cassette operable to be coupled with the turntable and configured to hold one or more ceramic packages; and
a spray post operable to distribute a cleaning solution onto the one or more ceramic packages.

11. The system of claim 10, wherein the spray post comprises a central spray post positioned essentially within the center of the process chamber.

12. The system of claim 10, wherein the spray post comprises a side-bowl spray post coupled to the side of the process chamber.

13. The system of claim 10, further comprising a mixing manifold operable to mix a plurality of chemicals into the cleaning solution and supply the cleaning solution to the spray post.

14. The system of claim 10, wherein the cleaning solution comprises ammonium hydroxide, hydrogen peroxide, and water.

15. The system of claim 10, wherein the spray post is further operable to distribute a rinse solution onto the one or more ceramic packages.

16. The system of claim 10, wherein the turntable is further operable to spin-dry the ceramic packages.
